(19) United States
(12) Patent Application Publication
(10) Pub. No.: US 2004/0112409 A1
(43) Pub. Date: Jun. 17, 2004

(54) Fluoride in supercritical fluid for photoresist and residue removal

(75) Inventor: Paul E. Schilling, Granite Bay, CA (US)

Correspondence Address: HAVERSTOCK & OWENS LLP, 162 North Wolfe Road, Sunnyvale, CA, 94086, US

(73) Assignee: Supercritical Sysems, Inc.

(21) Appl. No.: 10/321,341

(22) Filed: Dec. 16, 2002

(51) Int. Cl. B08B 7/00; B08B 3/00; B08B 3/12

(52) U.S. Cl. 134/26; 134/38; 134/201; 134/902

(57) ABSTRACT

A method and system for removing a residue from a substrate material is disclosed. The method and system utilize a supercritical cleaning solution with an fluoride source to control the concentration of fluoride ions and/or hydrogen fluoride within the supercritical cleaning solution. Preferably, the method and the system utilize a supercritical cleaning solution with supercritical CO₂ and an ammonium fluoride salt and/or an organo-ammonium fluoride and/or amine adduct. The supercritical cleaning solution, in accordance with further embodiments, includes one or more acids and one or more carrier solvents. The supercritical cleaning solution of the present invention is capable of removing a residue, such a post-etch photo polymer residue from a semiconductor substrate material by dissolution of the reside, etching a portion of the residue, etching a portion of the substrate material or any combination thereof.

### FIELD OF THE INVENTION

The present invention relates to the field of micro-device processing. More particularly, the present invention relates to the field of removal of residue from a substrate material using a supercritical cleaning solution.

### BACKGROUND OF THE INVENTION

Semiconductor fabrication generally uses photoresist in etching and other processing steps. In the etching steps, a photoresist masks areas of the semiconductor substrate that are not etched. Examples of the other processing steps include using a photoresist to mask areas of a semiconductor substrate in an ion implantation step or using the photoresist as a blanket protective coating of a processed wafer or using the photoresist as the blanket protective coating of a MEMS (micro electromechanical system) device.

Following the etching steps, remaining photoresist exhibits a hardened character that leads to difficulties in the photoresist removal. Following the etching steps, photoresist residue and other residues coat sidewalls of etch features and strongly adhere thereto. Depending on a type of etching step and material etched, these post etch residues, present a challenging removal problem. In order to remove such post etch residues wafers are usually treated by plasma ashing in an O₂ plasma followed by a wash with stripper chemicals. One of the shortcoming of cleaning wafers with stripper chemicals is that they generally contain water which can lead to the formation of unwanted oxides.

A number of techniques and systems have been developed which utilize supercritical solutions for cleaning wafers. In these techniques and systems, water can also be deleterious because of oxide formation and because the water can be difficult to remove from the cleaning system. Further, the presence of water can lead to unpredictable chemistry of the supercritical cleaning solution as explained in detail below.

What is needed is a more effective and efficient method of and system for removing a residue from a substrate material. Preferably, the method is suitable for removing residues from substrate materials including silicon, poly-silicon, silicon nitride, metal and silicon oxide substrate materials. Also, the method and system are preferably suitable for removing residues from low dielectric constant oxide materials and/or etched surfaces of oxide materials.

### SUMMARY OF THE INVENTION

The present invention is directed to a method of and system for treating a substrate material with a supercritical cleaning solution. In accordance with the embodiments of the present invention, a supercritical cleaning solution is generated which comprises supercritical CO₂ and an anhydrous fluoride source. The anhydrous fluoride source is generated within a supercritical CO₂ environment or, alternatively, is added to a supercritical CO₂ environment.

Anhydrous fluoride sources, in accordance with the present invention, provide a buffering environment to help control the concentration of fluoride ions, hydrogen fluoride and/or transition fluoride species that are available to react with a residue, dissolve the residue and/or react with the substrate material during the cleaning process.

An anhydrous fluoride source, in accordance with the embodiments of the invention, comprises an organo-ammonium fluoride. The phrase organo-ammonium fluoride herein refers to both ionic salts and adduct species, as explained in detail below. Salts are understood to mean species which typically dissociate in an aqueous environment to provide ammonium cations and fluoride anions. Adducts are understood to mean species which have an appreciable amount of tertiary amine and hydrogen fluoride in equilibrium with an appreciable amount of an ammonium cation and fluoride anions in an aqueous environment. It should be understood that while the anhydrous fluoride sources described herein are referenced in relation to their properties in an aqueous environment, the real behavior of such compounds within a supercritical CO₂ solvent environment is only approximated by their behavior in an aqueous environment.

Organo-ammonium fluorides in accordance with the present invention have at least one organo-group bonded directly to the nitrogen atom of the organo-ammonium fluoride. Suitable organo-groups include, but are not limited to, butyl, methyl, ethyl, alkyl, fluoro-alkyl, branched alkyl, unsaturated alkyl, alkyl halide and aromatic organogroups. Organo-ammonium fluorides, in accordance with further embodiments of the invention, comprise cyclic structures such as a pyrrolidone structures, pyridine structures and benzo-pyridine structures to name a few.

In accordance with an embodiment of the invention, a supercritical cleaning solution is generated using an ammonium fluoride salt ([NH₄]⁺[F]⁻) and an amount of an organic acid, such as formic acid, acetic acid, chloroacetic acid, trifluoroacedic acid, trichloroacidic acid, or any other suitable organic acid, to generate a controlled amount of fluoride ions and hydrogen fluoride within the supercritical cleaning solution.

In accordance with a further embodiment of the invention, a supercritical cleaning solution is generated using an ammonium fluoride salt and an amount of hydrogen fluoride and/or an amount of a hydrogen fluoride adduct to generate a controlled amount of fluoride ions and hydrogen fluoride within the supercritical cleaning solution. Such systems are believed to produce a buffered hydrogen fluoride cleaning solution which can include HF and poly-HF species, with a general formula of [Hₓ₋₁Fₓ]⁻.

Generally, the introduction of an ammonium fluoride salt into a supercritical cleaning environment requires the use of an aqueous carrier solvent. Accordingly, the use of an ammonium fluoride salt to provide a controlled amount of fluoride ions and hydrogen fluoride within the supercritical cleaning solution is not preferred, in cases where water is detrimental to the process and/or the processing equipment.

In an alternative embodiment of the invention a supercritical cleaning solution is generated by combining a tertiary amine with hydrogen fluoride, wherein the organoamine and the hydrogen fluoride are believed to form an adduct, with appreciable amounts of an ammonium fluoride salt in equilibrium with free hydrogen fluoride, the organo-amine to generate a controlled amount of fluoride ions and hydrogen fluoride within the supercritical cleaning solution.

In still further embodiments of the invention, a supercritical cleaning solution comprises one of more carrier solvents, such as N,N-dimethylacetamide (DMAC), gamma-butyrolacetone (BLO), dimethyl sulfoxide (DMSO), ethylene carbonate (EC) and N-methylpyrrolidone (NMP), to help introduce one or more anhydrous fluoride sources into the supercritical environment, wherein the supercritical environment preferably contains supercritical CO₂.

In operation, a supercritical cleaning solution is generated in a pressurized or compression chamber with a substrate structure comprising a substrate material and a residue therein. The substrate material can be any suitable material but is preferably a silicon based material and the residue is preferably a polymeric residue, such as a post etch photopolymer residue. The supercritical cleaning solution preferably comprises supercritical CO₂ and one or more anhydrous fluoride sources, as explained above. The supercritical cleaning solution is preferably agitated and/or circulated around the substrate structure to facilitate the cleaning process. The supercritical cleaning solution removes the residue from the substrate structure by dissolving the residue, etching the residue, etching a portion of the substrate material or any combination thereof. After the residue is removed from the substrate structure, the supercritical cleaning solution is decompressed or exhausted form the chamber along with the reside.

The cleaning process is performed any number of times on the substrate structure and includes any number of compression and decompression cycles necessary to remove the residue from the substrate structure. Further details of supercritical systems suitable for cleaning post etch residues from wafer substrates are described in U.S. patent application Ser. No. 09/389,788, filed Sep. 3, 1999, and entitled “REMOVAL OF PHOTORESIST AND PHOTORESIST RESIDUE FROM SEMICONDUCTORS USING SUPERCRITICAL CARBON DIOXIDE PROCESS and U.S. patent application Ser. No. 09/697,222, filed Oct. 25, 2000, and entitled “REMOVAL OF PHOTORESIST AND RESIDUE FROM SUBSTRATE USING SUPERCRITICAL CARBON DIOXIDE PROCESS”, both of which are hereby incorporated by reference.

In accordance with the embodiments of the invention, after the substrate structure is treated in one or more cleaning cycles, the substrate structure is then treated with a supercritical rinse solution in a rinse process or rinse cycle. The rinse process or rinse cycle is used to remove trace amounts of remaining residue from the substrate structure and/or to remove stripper chemicals used in the cleaning process or cleaning cycle from the substrate structure and/or from the processing chamber. The supercritical rinse solution preferably comprises supercritical CO₂ and one or more organic solvents which again is preferably agitated and/or circulated around the substrate structure within the chamber while the chamber is in a compression mode. The supercritical rinse solution and the trace amounts of remaining residue and/or stripper chemicals are then removed from the chamber by decompressing or exhausting the rinse solution from the chamber. The rinse process or rinse cycle is repeated any number of times as necessary and can be performed between multiple cleaning cycles.

The cleaning process or cleaning cycle utilized in the present is preferably performed under conditions which are substantially free of water. However, it will be understood by one skilled in the art that trace amounts of water are present in most processing methods and systems, and the present invention is directed to a method and system which utilize reduced amounts of water to provide a supercritical cleaning environment with controllable and predictable amounts of active cleaning species (fluoride ions, hydrogen fluoride and fluoride aggregates) through the use of an anhydrous fluoride source.

### BRIEF DESCRIPTION OF THE DRAWINGS

FIGS. 1A-B illustrate the formation of organo-ammonium salts and their use as a source of fluoride ions to control the concentration of fluoride ions and hydrogen fluoride in a supercritical cleaning solution, in accordance with the embodiments of the present invention.

FIG. 2 illustrates an anhydrous hydrogen fluoride source in equilibrium with an ammonium hydrogen fluoride adduct used to control the concentration of fluoride ions and hydrogen fluoride in a supercritical cleaning solution, in accordance with the embodiments of the present invention.

FIG. 3 show organo amines utilized to form hydrogen fluoride adducts used to provide a controlled concentration of fluoride ions and hydrogen fluoride in a supercritical cleaning solution, in accordance with the embodiments of the present invention.

FIG. 4 illustrates a first via structure subsequent to an RIE etch and prior to a photoresist and residue removal.

FIG. 5 illustrates a second via structure subsequent to the RIE etch and prior to the photoresist and residue removal.

FIG. 6 illustrates a metal line structure subsequent to the RIE etch and prior to a residue removal.

FIG. 7 illustrates a dual damascene structure subsequent to the RIE etch and prior to the photoresist and residue removal.

FIG. 8 is a flow chart illustrating steps of the preferred method of the present invention.

FIG. 9 illustrates the preferred processing system of the present invention.

FIG. 10 is the preferred time line of the present invention.

### DETAILED DESCRIPTION OF THE PREFERRED EMBODIMENT

The present invention is directed to a method and system for removing a residue from a substrate material, including but not limited to silicon-based and metal-based substrate materials. The present invention preferably utilizes a supercritical CO₂ cleaning solution and a fluoride source to control the concentration of fluoride, hydrogen fluoride or fluoride aggregates within the cleaning solution and is particularly well suited for removing a residue, such post etch photoresist residues, from a silicon oxide material.

A fluoride source is an aqueous-based fluoride source, is an organic-based fluoride source or is a combination of an aqueous and organic-based fluoride source. The fluoride source, in accordance with the embodiments of the invention, comprises an ammonium salt and/or a hydrogen fluoride adduct in combination with one or more acids or hydrogen ion sources and/or one or more carrier solvents to control the concentrations of fluoride and hydrogen fluoride within the supercritical cleaning solution, as described in detail below.

Typically, during wafer processing the photoresist is placed on the wafer to mask a portion of the wafer in a preceding semiconductor fabrication process step such as an etching step. In the etching step, the photoresist masks areas of the wafer that are not etched while the non-masked regions are etched. In the etching step, the photoresist and the wafer are etched producing etch features while also producing the photoresist residue and the etch residue. Etching of the photoresist produces the photoresist residue. Etching of the etch features produces the etch residue. The photoresist and etch residue generally coat sidewalls of the etch features.

In some etching steps, the photoresist is not etched to completion so that a portion of the photoresist remains on the wafer following the etching step. In these etching steps, the etching process hardens remaining photoresist. In other etching steps, the photoresist is etched to completion so that no photoresist remains on the wafer after such etching steps. In the latter case only the residue, that is the photoresist residue and the etch residue, remains on the wafer.

The present invention is preferably directed to removing photoresist for 0.25 micron and smaller geometries. In other words, the present invention is preferably directed to removing I-line exposed photoresists and smaller wavelength exposed photoresists. These are UV, deep UV, and smaller geometry photoresists. Alternatively, the present invention is directed to removing larger geometry photoresists.

While the present invention is described in relation to applications for removing post etch residue material typically used in wafer processing, it will be clear to one skilled in the art that the present invention can bed used to remove any number of different residues (including polymers and oil) from any number of different materials (including silicon nitrides) and structures including micro-mechanical, micro-optical, micro-electrical structures and combination thereof.

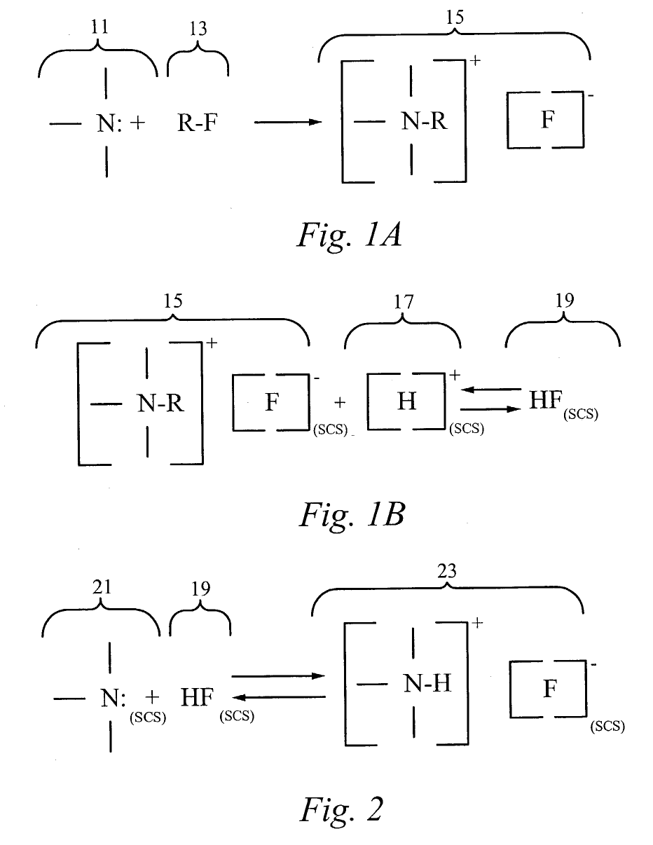

Referring to FIGS. 1A-B, in accordance with the embodiments of the invention, a supercritical cleaning solution (as indicated by the subscript SCS) comprises an organo-ammonium fluoride salt. Organo-ammonium fluoride salt herein refers to any ammonium salt which has at least one organo group bonded to the nitrogen of the ammonium cation of the salt, viz. [N(H_{4-R1+2+3+4})(R₁)(R₂)(R₃)(R₄)]⁺[F]⁻, wherein R₁₋₄ are the same or different.

Referring to FIG. 1A, an ammonium salt 15 can be prepared by reacting a tertiary amine 11 with a suitable alkyl fluoride compound 13. The aforementioned ammonium salt 15 is then used to provide a controllable source of fluoride ion that in turn provides a controllable concentration of hydrogen fluoride within the supercritical cleaning solution, as described below.

Now referring to FIG. 1B, to control the concentration of fluoride ions and/or hydrogen fluoride in the supercritical solution, an amount of the ammonium salt 15 is combined with supercritical CO₂ and an amount of hydrogen ion source 17 to generate the hydrogen fluoride 19 in situ. The hydrogen ion source is preferably added in the form of an organic acid, such as formic acid, acetic acid, chloroacetic acid, trifluoroacedic acid, trichloroacidic acid, or any other suitable organic acid. The fluoride ions [F]⁻ from the ammonium fluoride salt 15 and the hydrogen ions 17 from the hydrogen ion source establish an equilibrium to provide a controlled amount of hydrogen fluoride 19 and poly-HF species, with a general formula of [Hₓ₋₁Fₓ]⁻, within the supercritical cleaning solution.

Now referring to FIG. 2, a supercritical cleaning solution, in accordance with an alterative embodiment of the invention, is formed by adding an amount of a suitable tertiary amine 21 and an amount of hydrogen fluoride 19 within a supercritical CO₂ environment. The amine 21 and the hydrogen fluoride 19 are in equilibrium with an ammonium salt 23 to provide a controlled amount of fluoride ions [F]⁻ and hydrogen fluoride 19 within the supercritical cleaning solution. An amine that combines with hydrogen fluoride 19 and is in equilibrium with the ammonium salt 23 to provide the controlled amount of fluoride ions [F]⁻ and hydrogen fluoride 19 is referred to herein as an adduct.

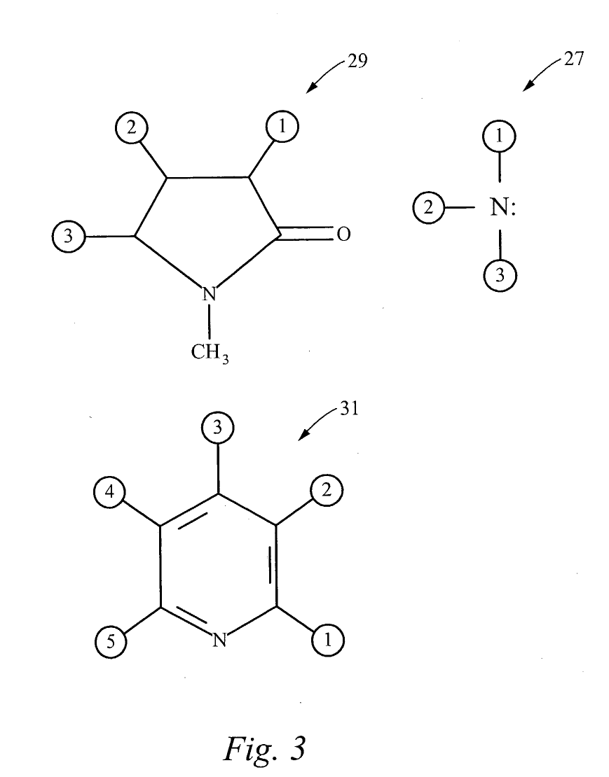

Referring now to FIG. 3, in accordance the embodiments of the invention, an amine 27 that is used to form an adduct with hydrogen fluoride comprises one or more organo-groups in the 1, 2 or 3 position. Suitable organo-groups include, but are not limited to, butyl, methyl, ethyl, alkyl, fluoro-alkyl, branched alkyl, unsaturated alkyl, alkyl halide, aromatic groups and combinations thereof. Alternatively, the amine structure includes a cyclic organo-group that is bonded to the nitrogen atom more than once, such as in the case of a pyridine 31 or pyrrolidone 29 amine. The pyrrolidone structure 29 and the pyridine structure 31, in accordance with the embodiments of the invention, have hydrogens or organo-groups attached to any one of the position 1-3 and 1-5, respectively.

In yet further embodiments of the invention, an amine that is used in a supercritical cleaning solution to form an adduct with hydrogen fluoride comprises a bicyclic structure such as a benzo-pyridine structure (not shown). In still further embodiments of the invention, a supercritical cleaning solution comprises one or more carrier solvents to help introduce the one or more of the aforementioned anhydrous fluoride sources into the supercritical environment and/or to enhance the solubility of one or more of the aforementioned anhydrous fluoride sources into the supercritical environment. A carrier solvent can also help in the dissolution or removal of residue from a substrate material in the cleaning process. Suitable carrier solvents include, but are not limited to, such as N,N-dimethylacetamide (DMAC), gamma-butyrolacetone (BLO), dimethyl sulfoxide (DMSO), ethylene carbonate (EC) N-methylpyrrolidone (NMP), dimethylpiperidone, propylene carbonate, alcohols (such a methanol, ethanol and 2-propanol) and combinations thereof.

The present invention is particularly well suited for removing post etch photopolymer from a wafer material and even more specifically is well suited to remove a post etch photopolymer from an oxide surface. It is believed that fluoride ions [F]⁻ combine with hydrogen fluoride within the supercritical cleaning solution to generate poly-HF species, with a general formula of [Hₓ₋₁Fₓ]⁻, and mostly in the from of [HF₂]⁻, which remove and/or etch a thin layer of oxide material just below the residue, thereby allowing the residue to be lifted and/or dissolved away from the oxide substrate material.

Using organo and anhydrous fluoride sources instead of aqueous fluoride ion sources has several advantages. Firstly, organo and anhydrous fluoride sources tend to be more soluble in low polarity carrier solvents and in supercritical CO₂, allowing for higher concentrations of fluoride ions [F]⁻ to react with a substrate material, react with the reside and/or dissolve residue during the cleaning process. The use a solvent other than water is preferred, not only to enhance the solubility of species within the supercritical CO₂ cleaning solution, but also to provide for the ability to eliminate the effects of hydrogen bonding with HF, typically associated with water, to allow for the adjustment of the dielectric constant of the solvent, thereby allowing for further control over the reactivity of the HF and associated species within the supercritical CO₂ cleaning solution. While the present invention described herein as preferably utilizing anhydrous fluoride sources, it is understood that a small amount of water is allowable, provided that the concentration of water is maintained below an amount which precludes the fluoride ions [F]⁻ from cleaning the substrate material.

A second advantage to using organo and anhydrous fluoride sources instead of aqueous fluoride ion sources is that the concentration of the active cleaning species (hydrogen fluoride and/or fluoride ion [F]⁻) can be more readily controlled by controlling the amount of ammonium salt, organic acid, hydrogen fluoride amine adduct, hydrogen fluoride or a combination thereof, that is added to the supercritical cleaning solution when creating a buffer environment. Since the concentration of fluoride ions [F]⁻ and hydrogen fluoride can be readily controlled, the performance of the supercritical cleaning solution is consistent between runs and the supercritical cleaning solution can be tailored to the specific application at hand.

An ability to control the concentration of the fluoride ions [F]⁻ ions is especially important for some oxides where the presence of fluoride ions [F]⁻ ions needs to be controlled at a low level in order to prevent degradation of the oxide. This is particularly so for porous oxide materials, such as porous MSQ and porous SiO₂ (e.g., Honeywell's NANOGLASS®). An excess concentration of fluoride ions [F]⁻ would remove the photoresist and the residue from the porous oxides but would also degrade the porous oxides as well.

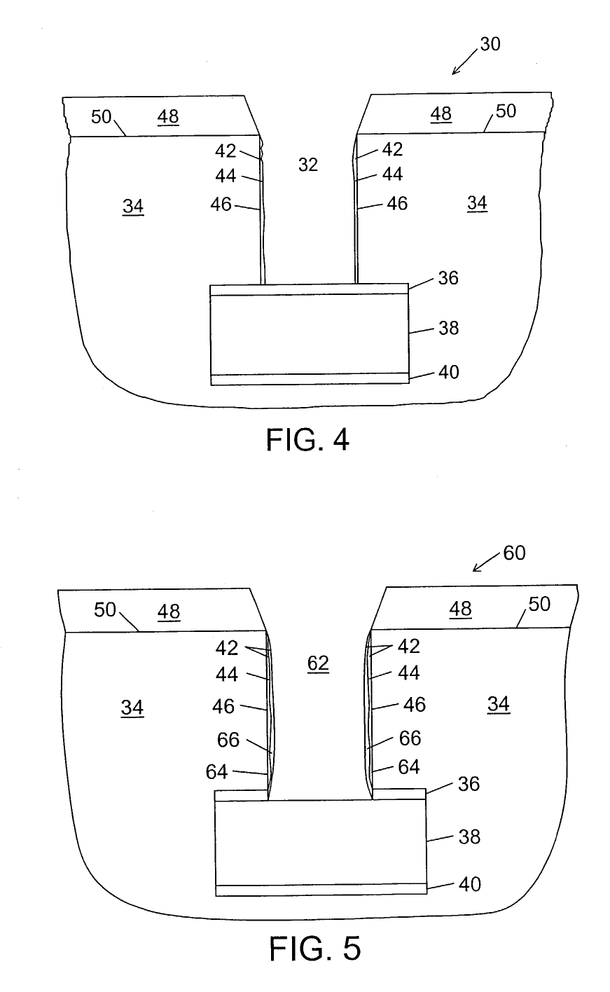

FIGS. 4-6 will mow be used to illustrate particular structures, where the implementation of the present invention can be used. FIG. 4 shows a first via structure 30 subsequent to an RIE (reactive ion etching) etch and prior to a photoresist and residue removal steps. The first via structure 30 includes a via 32 which is etched into a first SiO₂ layer 34 to a first TiN layer 36. In the first via structure 30, the via 32 stops at the first TiN layer 36 because the first TiN layer 36 provides an etch stop for the RIE etch of the first SiO₂ layer 34. Etching through the first TiN layer 36 complicates the RIE etch by requiring an additional etch chemistry for the first TiN layer 36; so for this particular etch, the TiN layer 36 is not etched. The first TiN layer 36 lies on a first Al layer 38, which lies on a first Ti layer 40. A first residue, which comprises photoresist residue 42 mixed with SiO₂ etch residue 44, coats sidewalls 46 of the via 32. A second photoresist 48 remains on an exposed surface 50 of the first SiO₂ layer 34. In the prior art, the second photoresist 48, the photoresist residue 42, and the SiO₂ etch residue 44 are removed using the plasma ashing and the stripper bath of the prior art. In particular, the stripper bath often employs a fluoride selected from an ammonium fluoride and a hydrofluoric acid, both of which employ water as a carrier solvent.

Note that specific layer materials and specific structure described relative to the first via structure 30, and to other thin film structures discussed herein, are illustrative. Many other layer materials and other structures are commonly employed in semiconductor fabrication.

FIG. 5 illustrates a second via structure 60 of the prior art subsequent to the RIE etch and prior to the photoresist and residue removal. The second via structure 60 includes a second via 62 which is etched through the first SiO₂ layer 34 and the first TiN layer 36 to the first Al layer 38. By etching through the first TiN layer 36, a device performance is improved because a contact resistance with the first Al layer 38 is lower than the contact resistance with the first TiN layer 36. The second via structure 60 also includes a first Ti layer 40 adjacent to the first Al layer 38. The first residue, which comprises the photoresist residue 42 mixed with the SiO₂ etch residue 44, coats second sidewalls 64 of the second via 62. A second residue, which comprises the photoresist residue 42 mixed with TiN etch residue 66, coats the first residue. The second photoresist 48 remains on the exposed surface 50 of the first SiO₂ layer 34. In the prior art, the second photoresist 48, the photoresist residue 42, the SiO₂ etch residue 44, and the TiN etch residue 66 are removed using the plasma ashing and the stripper bath of the prior art. Unlike the first via structure 30, the stripper bath for the second via structure does not employ the fluoride selected from the ammonium fluoride and the hydrofluoric acid because the fluoride reacts with the first Al layer 38.

Note that the first residue (FIGS. 4 and 5) and the second residue (FIG. 5) are worst case scenarios. Depending upon a specific etch process, the first residue or the second residue might not be present.

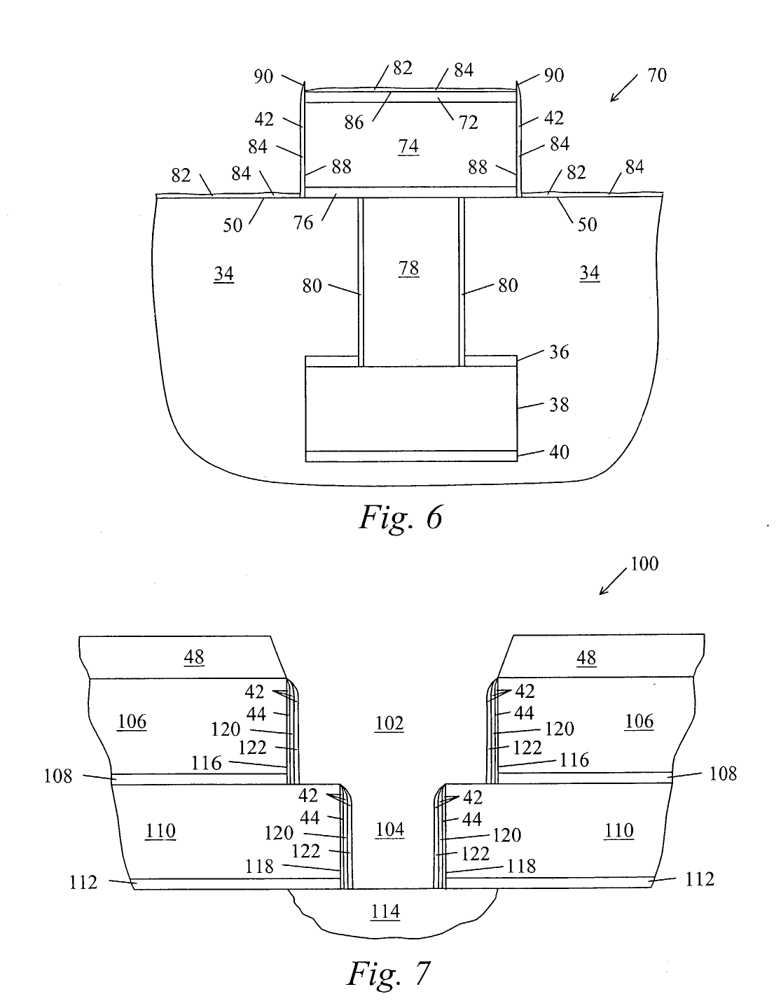

FIG. 6 illustrates a metal line structure 70 subsequent to a metal RIE etch and prior to a residue removal. The metal line structure 70 includes a second TiN layer 72 on a second Al layer 74 which is on a second Ti layer 76. The second TiN layer 72, the second Al layer 74, and the second Ti layer 76 form a metal line. The second Ti layer 76 contacts a W via 78, which in turn contacts the first Al layer 38. The W via 78 is separated from the first SiO₂ layer 34 by a sidewall barrier 80. A third residue, which comprises a halogen residue 82 mixed with metal etch residue 84, lies on the exposed surface 50 of the first SiO₂ layer 34. The third residue, which comprises the halogen residue 82 and the metal etch residue 84, also lies on a second exposed surface 86 of the second TiN layer 72. A fourth residue, which comprises a combination of the photoresist residue 42 mixed with metal etch residue 84, coats sides 88 of the metal line. Skirts 90 of the fourth residue extend above the second exposed surface 86 of the second TiN layer 72. In the prior art, the photoresist residue 42, the halogen residue 82, and the metal etch residue 84 are removed using the plasma ashing and the stripper bath of the prior art where the stripper bath employs the fluoride selected from the ammonium fluoride and the hydrofluoric acid.

FIG.7 illustrates a dual damascene structure 100 of the prior art subsequent to a dual damascene RIE etch and prior to the photoresist and photoresist residue removal. The dual damascene structure 100 includes a dual damascene line 102 formed above a dual damascene via 104. The dual damascene line 102 is etched through a second SiO₂ layer 106 and a first SiN layer 108. The dual damascene via 104 is etched through a third SiO₂ layer 110 and a second SiN layer 112. The dual damascene via 104 is etched to an underlying Cu layer 114.

In processing subsequent to the photoresist and residue removal, exposed surfaces of the dual damascene line and via, 102 and 104, are coated with a barrier layer and then the dual damascene line and via, 102 and 104, are filled with Cu.

Returning to FIG. 7, a fifth residue, which comprises the photoresist residue 42 mixed with the SiO₂ etch residue 44, coats line sidewalls 116 and via sidewalls 118. A sixth residue, which comprises the photoresist residue 42 mixed with SiN etch residue 120, coats the fifth residue. A seventh residue, which comprises the photoresist residue 42 mixed with Cu etch residue 122, coats the sixth residue. The photoresist 48 remains on a second exposed surface of the second SiO₂ layer 106. In the prior art, the photoresist 48, the photoresist residue 42, the SiO₂ etch residue 44, the SiN etch residue 120, and the Cu etch residue 122 are removed by the plasma ashing and the stripper bath of the prior art where the stripper bath employs the fluoride selected from the ammonium fluoride and the hydrofluoric acid.

Note that the fifth, sixth, and seventh residues are worst case scenarios. Depending upon a specific etch process, the fifth, sixth, or seventh residue might not be present.

Regardless of the method used to build or fabricate a micro device or the material used therein, there is typically one or more step whereby the wafer becomes contaminated with one or more processing residues, the most notably of which is a post etch photo polymer residue. Recent developments in semiconductor technology have led to proposed replacement of the second and third dielectric layers, 106 and 110, of the dual damascene structure 100 with low dielectric constant materials. Replacing the second and third dielectric layers, 106 and 110, with the low dielectric constant materials enhances an electronic device speed. Current efforts to develop the low dielectric constant materials have led to first and second categories of the low dielectric constant materials. The first category of dielectric materials are spin-on polymers, which are highly cross-linked polymers specifically designed to provide a low dielectric constant. An example of a spin-on polymer is Dow Chemical's SILK®. The second category of low dielectric constant materials are low dielectric constant oxide materials. A first example of a low dielectric constant oxide material is a C—SiO₂ material in which C (carbon) lowers an SiO₂ dielectric constant. A second example of a low dielectric constant oxide material is a porous SiO₂ material in which voids in the porous SiO₂ material lower the SiO₂ dielectric constant.

Via and line geometries are progressing to smaller dimensions and larger depth to width ratios. As the via and line geometries progress to the smaller dimensions and larger depth to width ratios, the plasma ashing and the stripper bath of the prior art are becoming less effective at removal of photoresist and photoresist residue. Further, removal of photoresist or residue or photoresist and residue from oxide materials presents a difficult problem because the photoresist and the residue tend to bond strongly to the oxide materials. The present invention provides for the ability to remove residue form a range substrate material, including the aforementioned oxide materials.

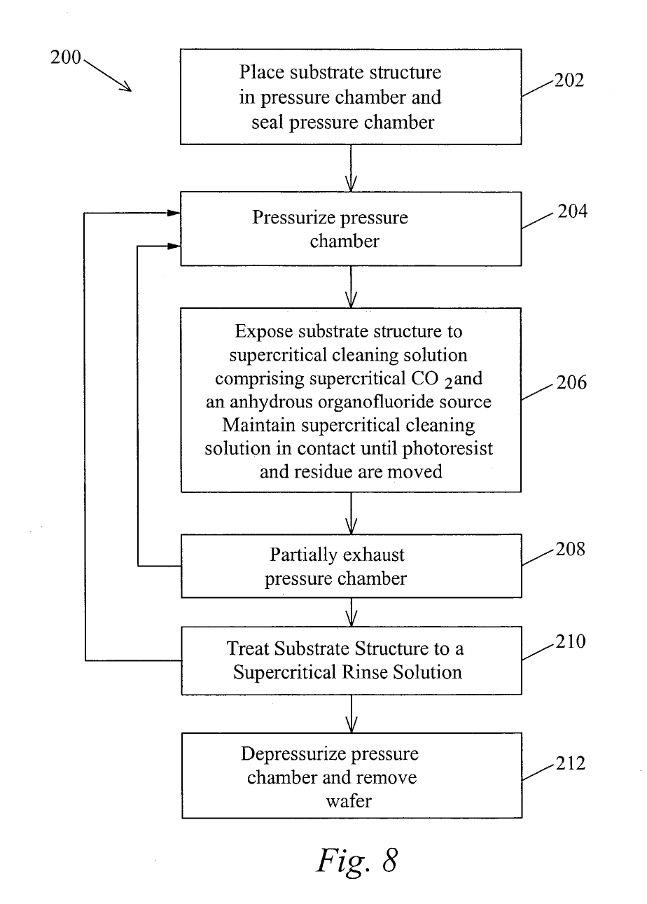

FIG. 8 is a block diagram 200 outlining steps for treating a substrate structure comprising any number of different structural features formed from any number of different material, such as described in detail above, with a supercritical cleaning solution that comprises one or more anhydrous fluoride source. In the step 202 a substrate structure with a residue, such a post etch photopolymer residue, is placed within a pressure chamber and the pressure chamber is sealed. After the substrate structure is placed within the chamber in the step 202, then in the step 204 the chamber is pressurized with CO₂ and at least one anhydrous fluoride source to form a supercritical cleaning solution. After the supercritical cleaning solution is generated in the step 204, then in the step 206 the substrate structure is exposed to the supercritical cleaning solution and maintained in the supercritical cleaning solution for a period of time required to remove at least a portion of the residue material from the substrate structure. During the step 206, the supercritical cleaning solution is preferably circulated through the chamber and/or otherwise agitated to move the supercritical cleaning solution over the surface of the substrate.

Still referring to FIG. 8, after at least a portion of the reside is removed from the substrate in the step 206, the chamber is partially exhausted in the step 208. The cleaning process comprising the steps 204 and 206 is repeated any number of times using a fresh supercritical cleaning solution and one or more anhydrous fluoride sources, as indicated by the arrow connecting the steps 208 to 204, as required to remove the residue from the substrate structure.

Still referring to FIG. 8, after the cleaning process or cycle comprising the steps 204, 206 and 208 is complete, then the substrate structure, in accordance with the embodiments of the invention, is treated to a supercritical rinsing solution. The supercritical rinsing solution preferably comprises supercritical CO₂ and one or more organic solvents, but can be pure supercritical CO₂.

Still referring to FIG. 8, after the substrate structure is cleaned and rinsed in the step 210, then in the step 212 the chamber is depressurized and the substrate structure is removed from the chamber. Alternatively, the substrate structure is recycled through the cleaning process comprising the steps 204, 206 and 208 as indicated by the arrow connecting steps 210 and 204 and/or the substrate structure is cycled through several rinse cycles prior to removing the substrate structure form the chamber in the step 212.

As described previously, the supercritical cleaning solution utilized in the present invention can also include one or more carrier solvents and one or more organic acids. Preferably, however, at least the supercritical cleaning solution is substantially anhydrous for reasons previously discussed. Also, it will be clear to one skilled in the art that any number of different treatment sequences are within the scope of the invention. For example, cleaning steps and rinsing steps can be combined in any number of different ways to achieve removal of a residue from a substrate structure.

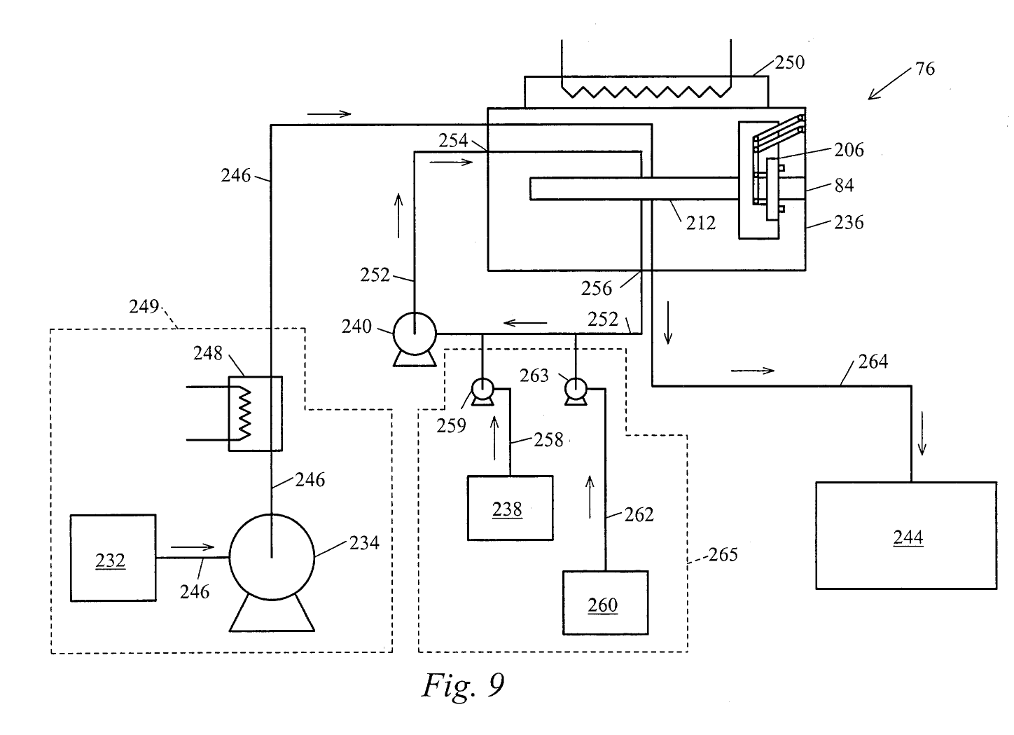

A supercritical processing module 76 for cleaning a wafer with a supercritical cleaning solution is illustrated in FIG. 9. The supercritical processing module 76 includes a carbon dioxide supply vessel 232, a carbon dioxide pump 234, the pressure chamber 236, a chemical supply vessel 238, a circulation pump 240, and an exhaust gas collection vessel 244. The carbon dioxide supply vessel 232 is coupled to the pressure chamber 236 via the carbon dioxide pump 234 and carbon dioxide piping 246. The carbon dioxide piping 246 includes a carbon dioxide heater 248 located between the carbon dioxide pump 234 and the pressure chamber 236. The pressure chamber 236 includes a pressure chamber heater 250. The circulation pump 240 is located on a circulation line 252, which couples to the pressure chamber 236 at a circulation inlet 254 and at a circulation outlet 256. The chemical supply vessel 238 is coupled to the circulation line 252 via a chemical supply line 258, which includes a first injection pump 259. A rinse agent supply vessel 260 is coupled to the circulation line 252 via a rinse supply line 262, which includes a second injection pump 263. The exhaust gas collection vessel 244 is coupled to the pressure chamber 236 via exhaust gas piping 264.

The carbon dioxide supply vessel 232, the carbon dioxide pump 234, and the carbon dioxide heater 248 form a carbon dioxide supply arrangement 249. The chemical supply vessel 238, the first injection pump 259, the rinse agent supply vessel 260, and the second injection pump 263 form a chemical and rinse agent supply arrangement 265.

It will be readily apparent to one skilled in the art that the supercritical processing module 76 includes valving, control electronics, filters, and utility hookups which are typical of supercritical fluid processing systems.

Still referring to FIG. 9, in operation a wafer with a residue thereon is inserted into the wafer cavity 212 of the pressure chamber 236 and the pressure chamber 236 is sealed by closing the gate valve 206. The pressure chamber 236 is pressurized by the carbon dioxide pump 234 with the carbon dioxide from the carbon dioxide supply vessel 232 and the carbon dioxide is heated by the carbon dioxide heater 248 while the pressure chamber 236 is heated by the pressure chamber heater 250 to ensure that a temperature of the carbon dioxide in the pressure chamber 236 is above a critical temperature. The critical temperature for the carbon dioxide is 31° C. Preferably, the temperature of the carbon dioxide in the pressure chamber 236 is within a range of 45° C. to 75° C. Alternatively, the temperature of the carbon dioxide in the pressure chamber 236 is maintained within a range of from 31° C. to about 100° C. Upon reaching initial supercritical conditions, the first injection pump 259 pumps the stripper chemistry, comprising an anhydrous fluoride source form a chemical supply vessel 238 into the pressure chamber 236 via the circulation line 252 while the carbon dioxide pump further pressurizes the supercritical carbon dioxide. At the beginning of the addition of the stripper chemistry to the pressure chamber 236, the pressure in the pressure chamber 236 is preferably about 1,100-1,200 psi. Once a desired amount of the stripper chemistry has been pumped into the pressure chamber 236 and desired supercritical conditions are reached, the carbon dioxide pump 234 stops pressurizing the pressure chamber 236, the first injection pump 259 stops pumping stripper chemistry into the pressure chamber 236, and the circulation pump 240 begins circulating the supercritical cleaning solution comprising the supercritical carbon dioxide and the stripper chemistry. Preferably, the pressure at this point is about 2,700-2,800 psi. By circulating the supercritical cleaning solution, solution is replenished quickly at the surface of the wafer thereby enhancing the removal of the photoresist and the residue from the wafer. Preferably, the wafer is held stationary within the pressure chamber 236 during the cleaning process. Alternatively, the wafer is spun within the pressure chamber 236 during the cleaning process.

After at least a portion of the residue has been removed from the wafer, the pressure chamber 236 is partially depressurized by exhausting some of the supercritical cleaning solution to an exhaust gas collection vessel 244 in order to return conditions in the pressure chamber 236 to near the initial supercritical conditions. Preferably, the pressure within the pressure chamber 236 is cycled at least once at this point by raising the pressure and then again partially exhausting the pressure chamber 236. This enhances a cleanliness within the pressure chamber 236.

While the pressure chamber partially decompresses, the pump 263 pumps a rinse agent from the rinse agent supply vessel 260 into the pressure chamber 236 via the circulation line while the carbon dioxide pump 234 pressurizes the pressure chamber 236 to near the desired supercritical conditions to generate a supercritical rinse solution. The supercritical rinse solution is then circulated with the pump 240 to rinse the wafer of striper chemistry used during the cleaning cycle. Preferably, the rinse agent comprises one or more organic solvent such as isopropyl alcohol or ethanol. Again the wafer is preferably held stationary in the pressure chamber 236 during the rinse cycle or, alternatively, the wafer is spun within the pressure chamber 236 during the rinse cycle. After the wafer is treated to the supercritical rinse solution, then the pressure chamber 236 is depressurized, by exhausting the pressure chamber 236 to the exhaust into the collection vessel 244 and the wafer is removed from the pressure chamber 236 through the gate valve 206.

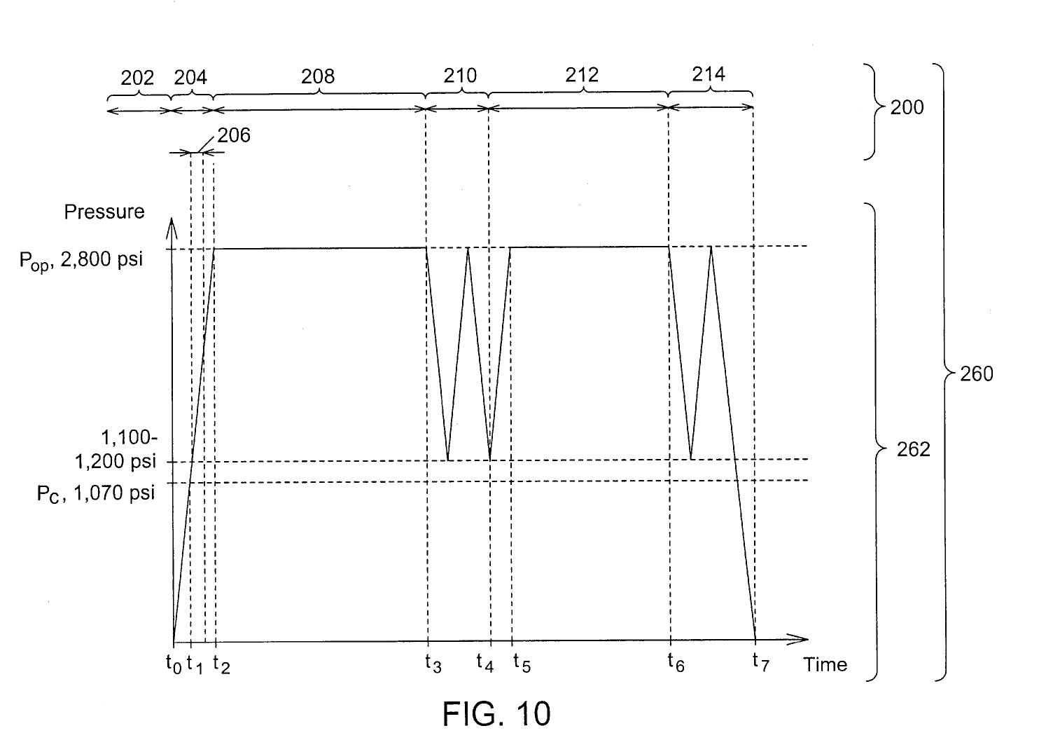

An exemplary time line 260 of a cleaning cycle and a rinsing cycle is graphically illustrated in FIG. 10. It will be readily apparent to one skilled in the art that the time axis in FIG. 10 is only illustrative and as such does not indicate relative time periods to scale. Ideally, of course, all times would be minimized within reason to obtain an economical and efficient processing method.

Referring now to FIGS. 9-10, prior to an initial time to, the wafer is placed within the pressure chamber 236 and the pressure chamber 236 is sealed in the first process step 202. From the initial time t₀ through a first time t₁ to a second time t₂, the pressure chamber 236 is pressurized. The pressure chamber 236 reaches critical pressure P_{c} at the first time t₁. The critical pressure P_{c} for the supercritical carbon dioxide is 1,070 psi. Preferably, the anhydrous fluoride source and a carrier solvent are injected into the pressure chamber 236 between the first time t₁ and the second time t₂. Preferably, the anhydrous fluoride source and carrier solvent injection begins upon reaching about 1100-1200 psi. Alternatively, the anhydrous fluoride source and the carrier solvent are injected into the pressure chamber around the second time t₂ or after the second time t₂. The pressure chamber reaches an operating pressure Pₒₚ at the second time t₂. Preferably, the operating pressure Pₒₚ is about 2,800 psi. Alternatively, the operating pressure Pₒₚ is within the range of from 1,070 psi to about 6,000 psi.

The preferred timeline 260 continues with maintaining the supercritical cleaning solution in contact with the wafer until the residue or residues are removed the wafer, which takes place from the second time t₂ to a third time t₃. Then the pressure chamber 236 is partially exhausted from the third time t₃ to a fourth time t₄. Preferably, this is accomplished by dropping from the operating pressure Pₒₚ to about the 1,100-1,200 psi in a first exhaust, raising from the 1,100-1,200 psi to the operating pressure Pₒₚ in a first pressure recharge, and dropping again to the 1,100-1,200 psi in a second exhaust. Alternatively, the pressure recharge and the second exhaust are not performed or, alternatively, additional recharges and exhausts are performed wherein one or more of the exhausts can be a full exhaust.

The preferred timeline 260 continues with the rinsing cycle form the time fourth t₄ through fifth time t₅ and to the sixth time t₆. With a second pressure recharge during which the rinse agent is preferably injected into the pressure chamber 226 from the fourth time t₄ to the fifth time t₅. In the seventh process step 214, the pressure chamber 226 is exhausted from the sixth time t₆ to a seventh time t₇. Preferably, this is accomplished by dropping the operating pressure Pₒₚ to about the 1,100-1,200 psi in a third exhaust, raising from the 1,100-1,200 psi to the operating pressure Pₒₚ in a third pressure recharge, and finally dropping to atmospheric pressure in a final exhaust. Alternatively, the third exhaust and the third pressure recharge are not performed or, alternatively, additional exhausts and recharges are performed as part of the seventh process step 210.

Any number of cleaning cycles and rinse cycles sequences with each cycle having any number of compression and decompression steps are contemplated and the example above is intended for illustration and completeness only and is no way intended to limit the scope the present invention. Also as stated previously, concentrations various chemicals and species withing a supercritical cleaning solution and the supercritical rinse solution can be readily tailored for the application at hand.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiments chosen for illustration without departing from the spirit and scope of the invention. Specifically, while supercritical CO₂ is the preferred medium for cleaning other supercritical media alone or in combination with supercritical CO₂ are contemplated. Combination of various ammonium fluoride slats and hydrogen fluoride adducts can also be used as a source anhydrous fluoride and/or hydrous fluoride in a supercritical cleaning solution.

What is claimed is:

1. A method comprising:
a. maintaining a substrate structure comprising a substrate material and residue thereon within a supercritical cleaning solution, the supercritical cleaning solution comprising supercritical CO₂ and a fluoride source, whereby the fluoride source facilitates dissolution of the residue from the substrate material; and
b. removing the supercritical solution and the residue away from the substrate material.

2. The method of claim 1, wherein the fluoride source comprises a organo-ammonium fluoride.

3. The method of claim 2, where the organo-ammonium fluoride comprises a cyclic organo-ammonium fluoride.

4. The method of claim 2, wherein the organo-ammonium fluoride comprises a pyrrolidone structure.

5. The method of claim 3, wherein the cyclic organo-ammonium fluoride is unsaturated.

6. The method of claim 5, wherein the cyclic organo-ammonium fluoride comprises a pyridine structure.

7. The method of claim 6, wherein the pyridine structure is a benzo-pyridine structure.

8. The method of claim 2, wherein the organo ammonium fluoride is a quaternary organo ammonium fluoride having a chemical formula [R₁R₂R₃R₄N]⁺[F]⁻.

9. The method of claim 8, wherein one or more of R₁, R₂, R₃, and R₄ comprises a group selected from an alkyl and an aromatic group.

10. The method of claim 2, wherein the organo-ammonium fluoride is a tertiary ammonium fluoride having a chemical formula [R₁R₂R₃HN]⁺[F]⁻.

11. The method of claim 10, wherein one or more of the R₁, R₂ and R₃ comprises a group selected from a butyl, methyl, ethyl, alkyl, fluoro-alkyl, branched alkyl, an unsaturated alkyl, alkyl halide and an aromatic group.

12. The method of claim 1, wherein the supercritical cleaning solution further comprises an organic acid.

13. The method of claim 12, wherein the organic acid is an organic acid selected from the group consisting of formic acid, acetic acid, chloroacetic acid, trifluoroacedic acid and trichloroacidic acid.

14. The method of claim 1, wherein the supercritical cleaning solution further comprises a carrier solvent.

15. The method of claim 14, wherein the carrier solvent is selected from the group consisting of as N,N-dimethylacetamide (DMAC), gamma-butyrolacetone (BLO), dimethyl sulfoxide (DMSO), ethylene carbonate (EC) N-methylpyrrolidone (NMP), dimethylpiperidone, propylene carbonate and alcohol.

16. The method of claim 1, wherein the residue comprises a polymer.

17. The method of claim 16, wherein the polymer is a photoresist polymer.

18. The method of claim 1, wherein the substrate material comprises a silicon dioxide.

19. The method of claim 1, further comprising washing the substrate material with a supercritical rinsing solution after removing the supercritical cleaning solution and the residue away from the substrate material.

20. The method of claim 19, wherein the supercritical rinsing solution comprises CO₂ and an organic solvent.

21. The method of claim 20, wherein the organic solvent is selected from the group consisting of as N,N-dimethylacetamide (DMAC), gamma-butyrolacetone (BLO), dimethyl sulfoxide (DMSO), ethylene carbonate (EC) N-methylpyrrolidone (NMP), dimethylpiperidone, propylene carbonate and alcohol.

22. A system for cleaning a substrate, the system comprising a chamber for generating a supercritical solution comprising:
a. supercritical CO₂;
b. an amine comprising at least one organo group; and
c. hydrogen fluoride, wherein the at least a portion of the hydrogen fluoride and the amine form an ammonium fluoride adduct.

23. The system of claim 22, wherein the supercritical solution is substantially free of water.

24. The system of claim 22, wherein the amine is selected from the group consisting of a secondary ammine, a tertiary amine, a pyridine, a pyrrole and a pyrrolidone.

25. The system of claim 22, wherein the supercritical solution further comprises one or more organic carrier solvents.

26. The method of claim 22, wherein the supercritical solution further comprises one or more organic acids.

27. The system of claim 22, wherein the system is configured to clean silicon wafers.

28. A method of cleaning a substrate comprising:
a. generating a supercritical cleaning solution in the presence of the substrate, the supercritical solution comprising supercritical CO₂ and fluoride source;
b. circulating the supercritical cleaning solution; and
c. removing the supercritical cleaning solution.

29. The method of claim 28, wherein generating the supercritical cleaning solution comprises adding an amine and a carrier solution to a chamber.

30. The method of claim 29, wherein the carrier solution comprises one or more organic solvents and one or more organic acids.

31. The method of claim 28, wherein removing the supercritical cleaning solution comprises flushing the chamber with supercritical CO₂.

32. The method of claim 28, further comprising adding a rinse solution, after removing the supercritical cleaning solution, the rinse solution comprising supercritical CO₂ and one or more organic solvents.

32. The method of claim 28, wherein the cleaning solution is substantially anhydrous.
